(19) United States
(12) Patent Application Publication
(10) Pub. No.: US 2005/0058160 A1
(43) Pub. Date: Mar. 17, 2005

(54) Apparatus and method for providing secondary broadcast service in digital broadcasting system

(76) Inventor: Kyung-Ha Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/735,726

(22) Filed: Dec. 16, 2003

(30) Foreign Application Priority Data
Sep. 15, 2003 (KR) 2003-63680

(51) Int. Cl. H04J 3/06; H04B 7/216

(52) U.S. Cl. 370/512; 370/441

(57) ABSTRACT

An apparatus and method for providing secondary broadcast services in a digital broadcasting system including a transmitter and a receiver. The transmitter transmits summary information and control data of broadcast channels through a control channel while allocating the summary information and the control data to a data transmission section, and transmits a secondary broadcast corresponding to the summary information while allocating the summary information to at least one of a plurality of broadcast channels. The receiver receives a signal transmitted through the control channel, displays the summary information after retrieving the summary information from the data transmission section, and receives a broadcast channel through which the secondary broadcast corresponding to the summary information is transmitted when there is a request to receive the secondary broadcast.

### PRIORITY

This application claims priority to an application entitled “APPARATUS AND METHOD FOR PROVIDING SECONDARY BROADCAST SERVICE IN DIGITAL BROADCASTING SYSTEM”, filed in the Korean Intellectual Property Office on Sep. 15, 2003 and assigned Ser. No. 2003-63680, the contents of which are hereby incorporated by reference.

### BACKGROUND OF THE INVENTION

1. Field of the Invention

The present invention relates to a digital broadcasting system, and more particularly to a transmission/reception apparatus and method for providing a secondary broadcast in a digital broadcasting system.

2. Description of the Related Art

Digital broadcasting carries a plurality of programs compressed and multiplexed with high efficiency, which are broadcast through a satellite or terrestrial repeater. A digital broadcasting system employs a single control channel and a plurality of broadcast channels, which are divided through frequencies and spreading codes according to a modulation scheme adopted by the digital broadcasting system. The control channel is also called a pilot channel, which is used to transmit control data for the analysis of received signals, the synchronous detection of spreading signals, the control of a receiver, etc. The broadcast channels are used to transmit general broadcast programs. A digital broadcast receiver provides a user with a program in a broadcast channel selected by the user, under the control of control data received through the control channel.

In order to provide a user with a secondary broadcast regarding weather, accident information, traffic information, etc., the conventional digital broadcasting system must incorporate a secondary broadcast to be transmitted into a broadcast channel selected by the user. Accordingly, in order to provide the secondary broadcast to all users regardless of what channel they are watching, a system is required to insert the same secondary broadcast into all broadcast channels, which makes it difficult to perform efficient channel management. Thus, there is a need to develop technology to provide the secondary broadcast without wasting broadcasting resources.

In addition, the conventional digital broadcasting system provides the secondary broadcast to all users indiscriminately. Accordingly, the conventional system cannot meet demands of users who desire to receive a specific kind of secondary broadcast, or users who do not desire to receive the secondary broadcast, which causes inconvenience to the users. Therefore, there is also a need to create new technology to provide a differential secondary broadcast to satisfy the needs of users.

Accordingly, a need exists for a system and method to provide a transmission and reception apparatus for providing a secondary broadcast in a digital broadcasting system that efficiently provides the secondary broadcast and satisfies the different needs of multiple users.

### SUMMARY OF THE INVENTION

Therefore, the present invention has been made in view of the above problems, and it is an object of the present invention to provide a system and method that makes it possible to use a control channel for providing a secondary broadcast.

It is another object of the present invention to provide a system and method that makes it possible to provide summary information of a secondary broadcast through a control channel, and further to perform a conversion into a secondary broadcast channel according to a user's selection.

In accordance with an embodiment of the present invention, the above and other objects can be accomplished by a digital broadcasting system comprising: a transmitter for transmitting summary information and control data of broadcast channels through a control channel while allocating the summary information and the control data to a data transmission section, and transmitting a secondary broadcast corresponding to the summary information while allocating the summary information to at least one of a plurality of broadcast channels; and a receiver for receiving a signal transmitted through the control channel, displaying the summary information after retrieving the summary information from the data transmission section, and receiving a broadcast channel through which the secondary broadcast corresponding to the summary information is transmitted when there is a request to receive the secondary broadcast.

In accordance with another aspect of an embodiment of the present invention, a digital broadcasting system is provided comprising: a transmitter for dividing a data transmission section of a control channel into a control data section and a secondary broadcast section, and multiplexing summary information, control data of broadcast channels and a predetermined synchronous signal by allocating each to the secondary broadcast section, the control data section and a synchronous signal section of the control channel, respectively, and further transmitting each through the control channel; and a receiver for receiving a signal transmitted through the control channel, determining whether the summary information exists in the secondary broadcast section, and providing the summary information to a user after extracting the information from the secondary broadcast section.

In accordance with yet another aspect of an embodiment of the present invention, a device for receiving a secondary broadcast in a digital broadcasting system is provided employing a control channel and a plurality of broadcast channels, wherein the control channel includes a synchronous signal section and a data transmission section arranged alternately, the device comprising: a receiver for receiving signals of the control channel and a channel, selected by a user from the plurality of broadcast channels; a secondary broadcast determination means for determining whether summary information of a secondary broadcast exists in the data transmission section of the control channel at a predetermined position thereof; a secondary broadcast extractor for extracting the summary information transmitted while being inserted in the data transmission section at the predetermined position thereof; and a secondary broadcast reproducer for reproducing the extracted summary information and providing the information to the user.

In accordance with yet another aspect of an embodiment of the present invention, a method is provided for receiving a secondary broadcast in a digital broadcasting system employing a control channel and a plurality of broadcast channels, wherein the control channel includes a synchronous signal section and a data transmission section arranged alternately, the method comprising the steps of: a) receiving the control channel and a broadcast channel, selected by a user from the plurality of broadcast channels, and providing a program of the selected broadcast channel to the user; b) searching a secondary broadcast section in the data transmission section of the control channel to determine whether there is summary information; c) extracting the summary information from the secondary broadcast section; and d) reproducing the extracted summary information and providing the information to the user.

In accordance with still another aspect of an embodiment of the present invention, a method for providing a secondary broadcast in a digital broadcasting system is provided for employing a control channel and a plurality of broadcast channels, wherein the control channel transmits therethrough a synchronous signal section and a data transmission section alternately, the method comprising the steps of: a) dividing the data transmission section into a control data section and a secondary broadcast section, and allocating summary information and control data of the broadcast channels to the secondary broadcast section and the control data section, respectively; b) multiplexing the data transmission section and the synchronous signal section while arranging each alternately, and transmitting each through the control channel; c) receiving a signal transmitted through the control channel, and determining whether there is summary information in the secondary broadcast section; and d) reproducing the summary information after extracting the information from the secondary broadcast section.

In accordance with yet another aspect of an embodiment of the present invention, a method is provided for receiving a secondary broadcast in a digital broadcasting system employing a control channel and a plurality of broadcast channels, wherein the control channel includes a synchronous signal section and a data transmission section arranged alternately, the method comprising the steps of: a) receiving the control channel and a broadcast channel, selected by a user from the plurality of broadcast channels, and providing a program of the selected broadcast channel to the user; b) searching a secondary broadcast section in the data transmission section of the control channel to determine whether there is summary information; c) reproducing the summary information after extracting the information from the secondary broadcast section; d) retrieving a broadcast channel of said plurality of broadcast channels from the summary information, through which a secondary broadcast corresponding to the summary information is transmitted; and e) converting into the broadcast channel, through which the secondary broadcast is transmitted, in accordance with the user's request.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B show the structure of an example control channel in accordance with an embodiment of the present invention;

FIG. 2 is a block diagram showing the configuration of an example digital ,broadcast transmitter for generating a secondary broadcast transmission signal in accordance with an embodiment of the present invention;

FIG. 3 is a block diagram showing the configuration of an example digital broadcast receiver for receiving a secondary broadcast in accordance with an embodiment of the present invention; and

FIG. 4 is a flowchart showing a method for providing an example secondary broadcast in a digital broadcast receiver in accordance with an embodiment of the present invention.

### DETAILED DESCRIPTION OF THE PREFERRED EMBODIMENTS

Now, embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

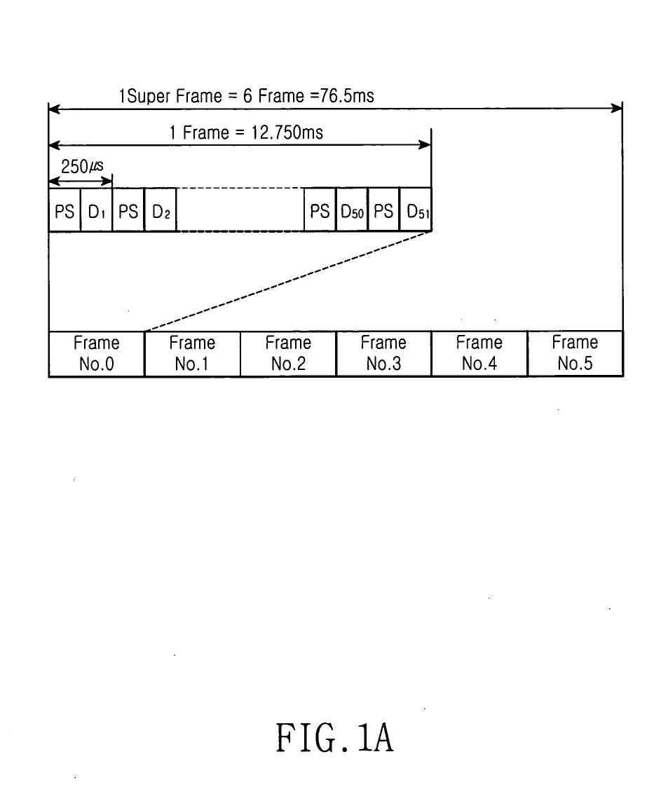

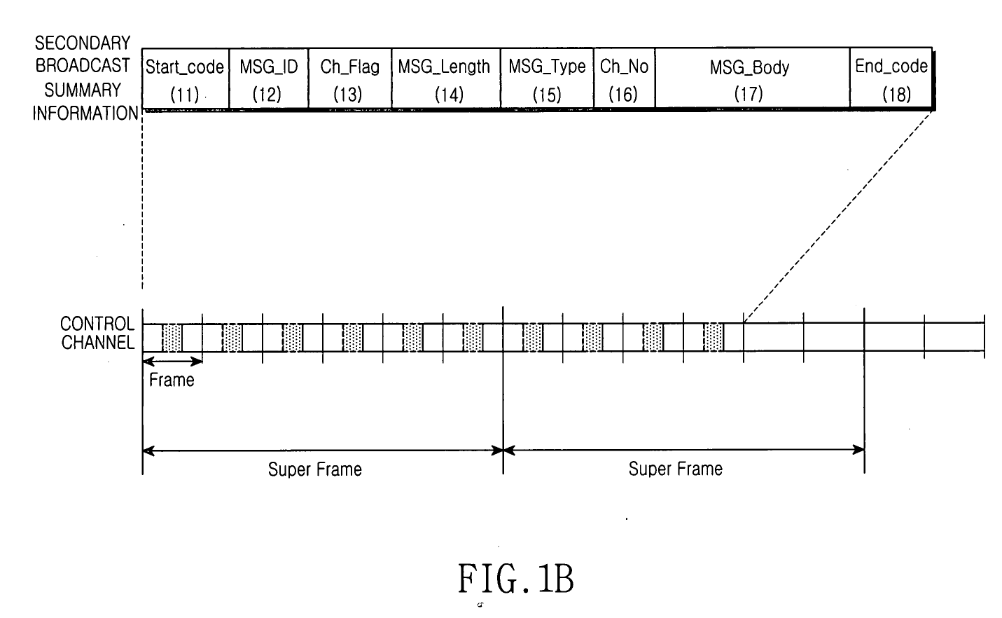

FIGS. 1A and 1B show the structure of a control channel according to an embodiment of the present invention. The structure of a control channel for transmitting the summary information of a secondary broadcast will now be described in detail with reference to FIGS. 1A and 1B.

FIG. 1A shows the structure of a transmission frame in a control channel used in a digital broadcasting system. As shown in this figure, the transmission frame of the control channel is composed of synchronous signal sections PS and data transmission sections D₁ to D₅₁ arranged alternately. The synchronous signal sections PS repeat at intervals of 250 μsec, in which a synchronous signal of 32 bits, i.e., a pilot symbol, is inserted. The data transmission sections are used for transmitting various control data, which are denoted by D₁ to D₅₁ in FIG. 1A. Each frame is composed of 51 pairs of synchronous signal sections PS and data transmission sections D₁ to D₅₁, and each super frame is composed of 6 frames.

A bit stream of a predetermined pattern is positioned in a data transmission section D₁ of the data transmission sections D₁ to D₅₁ to allow a receiver to establish frame synchronization, and a counter is positioned in a data transmission section D₂ in order to indicate the location of a corresponding frame in a super frame. Data transmission sections D₃ to D₅₀ are used to transmit overall control information and channel configuration information. The use areas and the configuration formats of the sections D₃ to D₅₀ are prescribed between a broadcaster and a receiver according to broadcasting environments, such as the type and number of broadcast channels that the broadcaster provides. In particular, according to an embodiment of the present invention, the sections D₃ to D₅₀ are divided into control data sections and secondary broadcast sections, and the summary information of a secondary broadcast is positioned in the secondary broadcast sections.

FIG. 1B shows the data structure of the summary information of a secondary broadcast according to an embodiment of the present invention. The following description will be given with reference to the example where the summary information of a secondary broadcast includes data such as a start code (Start_code) 11, an end code (End_code) 18, a message identifier (Msg_ID) 12, a channel flag (Ch-Flag) 13, a message length (Msg_Length) 14, a message type (Msg_Type) 15, a channel number (Ch-No) 16 and a message body (Msg_Body) 17. It should be noted that the summary information can be modified to further include other data, or exclude any part of the data described above.

The start code 11 and the end code 18 are bit streams of predetermined patterns, which allow a receiver to identify the start and the end of the summary information of the secondary broadcast, respectively. The message identifier 12 is data for identifying the transmitted secondary broadcast, and the message length 14 represents the length of the secondary broadcast summary information transmitted through the control channel. The receiver can estimate the location of the end bit stream, or end code 18 based on the message length 14, and compare the estimated location of the end bit stream with the real location of an end bit stream the receiver has already received to determine whether or not an error has occurred.

The message type 15 represents the type of the secondary broadcast. This description will be given upon the assumption that the type of the secondary broadcast is classified into one kind of message regarding weather, accident information, traffic information, etc., and another kind of message regarding video broadcast, audio broadcast, etc. The channel flag 13 indicates whether or not a secondary broadcast containing detailed content corresponding to the summary information is being transmitted through a broadcast channel. When the channel flag 13 is set, a specific area of the field of the message body 17 is used to represent the broadcast channel number 16.

The secondary broadcast summary information is inserted in secondary broadcast sections in the data transmission sections D₃ to D₅₀ of the control channel. The location of the secondary broadcast sections should preferably be prescribed between a broadcaster and a receiver. In general, the summary information is inserted in units of super frames in the control channel. That is, secondary broadcast sections of six frames corresponding to a single super frame constitutes a single insertion unit, and single secondary broadcast summary information is inserted in a divided manner into the single insertion unit of secondary broadcast sections. Further, in accordance with an embodiment of the present invention, it is also possible that the summary information is transmitted over a plurality of super frames when the size of the summary information is larger than that of the single insertion unit of secondary broadcast sections.

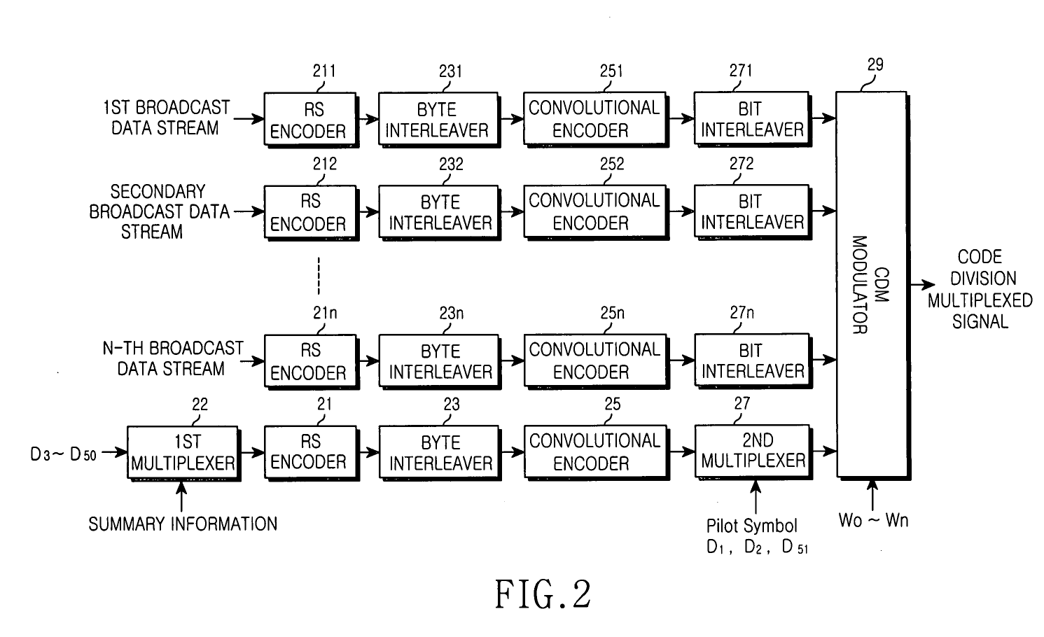

FIG. 2 is a block diagram showing the configuration of an example digital broadcast transmitter that generates a secondary broadcast transmission signal in accordance with an embodiment of the present invention. The following description will be given upon the assumption that the digital broadcasting system employs a code division multiplexing transmission scheme, but the embodiments of the present invention can also be applied when any number of different multiplexing transmission schemes are employed.

As shown in FIG. 2, control data transmitted through data transmission sections D₃ to D₅₀ is input to a first multiplexer 22. The first multiplexer 22 also receives the summary information of a secondary broadcast, and inserts the summary information into the control data so that the summary information is transmitted while being positioned in the secondary broadcast sections of the data transmission sections D₃ to D₅₀.

The control data is input to the first multiplexer 22 in units of frames, and the summary information is input thereto while being divided into a size corresponding to the size of secondary broadcast sections included in a single frame. The summary information is inserted into the control data in units of super frames. That is, even when the size of summary information is less than the size of secondary broadcast sections of a single super frame, the insertion of the next summary information begins at the next super frame. However, when the size of summary information is larger than the size of secondary broadcast sections of a single super frame, the summary information insertion is extended to the next super frame. It is preferable to transmit the summary information by repeatedly inserting the summary information into the control data at least two times according to the selection of a broadcaster.

The signal output from the first multiplexer 22 is encoded in a Reed-Solomon encoder 21, and is byte-interleaved in a byte interleaver 23. The signal output from the byte interleaver 23 is compressed/encoded in a convolutional encoder 25, and input to a second multiplexer 27. The second multiplexer 27 receives a pilot symbol, control data transmitted through the sections D₁, D₂ and D₅₁, and the compressed/encoded summary information and control data transmitted through the sections D₃ to D₅₀. The second multiplexer 27 allocates the pilot symbol to the synchronous signal sections, allocates the control data to the corresponding data transmission sections D1 to D51, allocates the summary information to the secondary broadcast sections, and generates a multiplexed control channel transmission signal. A CDM modulator 29 performs spreading modulation on the control channel transmission signal by using a control channel spreading code W₀.

Data streams of general broadcast programs transmitted through broadcast channels are encoded in the Reed-Solomon encoders 211 to 21n, respectively, and the data order thereof is rearranged on a byte-by-byte basis in the byte interleavers 231 to 23n. The data streams of general broadcast programs output from the byte interleavers 231 to 23n are compressed/encoded in the convolutional encoders 251 to 25n, respectively, and the data order thereof is rearranged on a bit-by-bit basis in bit interleavers 271 to 27n. After being subjected to the data order rearrangement, the data streams are spread-modulated in the CDM modulator 29 using the respective spreading codes W₁ to Wₙ of the broadcast channels. The ranges illustrated by values 211-21n, 231-23n, 251-25n, 271-27n and W₁ to Wₙ, are given as example ranges in accordance with an embodiment of the present invention, and are not restricted solely to these range values.

These data streams transmitted through the broadcast channels may contain a data stream of a secondary broadcast corresponding to the summary information transmitted through the control channel. The data stream of a secondary broadcast may be transmitted while occupying a single broadcast channel as in the embodiment shown, or may also be transmitted while being inserted in a broadcast channel through which a data stream of a different general broadcast is transmitted. The CDM modulator 29 multiplexes the spread-modulated transmission signals of the control channel and the broadcast channels to output a code division multiplexed transmission signal.

Although the above embodiment of the present invention has been described with reference to a specific example where the summary information of the secondary broadcast is inserted into the control data in the first multiplexer 22, the embodiments of the present invention are not limited to the above specific case. For example, the following modification is also possible in another embodiment of the present invention. That is, in a second embodiment example after each signal output from the first multiplexer 22 is compressed/encoded through Reed-Solomon encoding, byte interleaving and convolutional encoding, the control data and the secondary broadcast summary information can be positioned at the respective allocation areas by the multiplexer, and combined with the control data transmitted through the sections D₁ and D₂ and the pilot symbol. In addition, although the above embodiment has been described upon the assumption that the first multiplexer 22 handles the control data in units of frames, a modification thereof is also possible in another embodiment of the present invention in which the control data is handled in units of super frames.

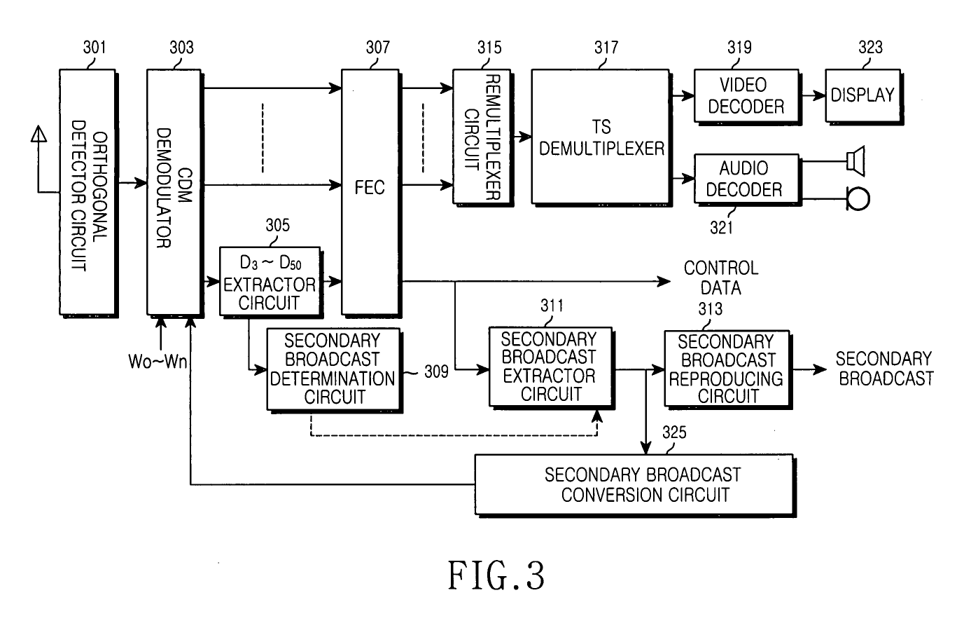

FIG. 3 is a block diagram showing the configuration of an example digital broadcast receiver for receiving a secondary broadcast in accordance with an embodiment of the present invention.

A code division multiplexed (CDM) transmission signal is orthogonally detected in an orthogonal detector circuit 301. A CDM demodulator 303 separates the CDM transmission signal into a control channel transmission signal and a broadcast channel transmission signal by using a spreading code. The spreading code corresponds to a channel selected by a user including a spreading code W₀ for the control channel, and spreading codes W₁ to Wₙ for the general broadcast channels. A D₃-to-D₅₀ extraction circuit 305 receives the control channel transmission signal and extracts data inserted in the data transmission sections. The receiver generates frame and super-frame timing signals by using the sections D₁ and D₂. The extracted data of the data transmission sections D₃ to D₅₀ is provided to an error corrector 307. The extracted data of D₃ to D₅₀ is also provided to a secondary broadcast determination circuit 309. The secondary broadcast determination circuit 309 determines whether or not the summary information of a secondary broadcast exists in secondary broadcast sections in the extracted data transmission sections D₃ to D₅₀. When the summary information exists, the determination circuit 309 outputs a control signal to a secondary broadcast extraction circuit 311.

The error corrector 307 corrects transmission errors in the control channel and broadcast channel transmission signals output from the CDM demodulator 303. The secondary broadcast extraction circuit 311 receives the control signal from the secondary broadcast determination circuit 309, and separates the data of the data transmission sections D₃ to D₅₀ output from the error corrector 307 into control data and the summary information of a secondary broadcast. The secondary broadcast extraction circuit 311 checks whether a start code 11 is present in the summary information, which is extracted from the secondary broadcast sections in units of super frames according to the frame and super-frame timing signals, and detects a message identifier 12 if the checked result indicates the start code 11 is present.

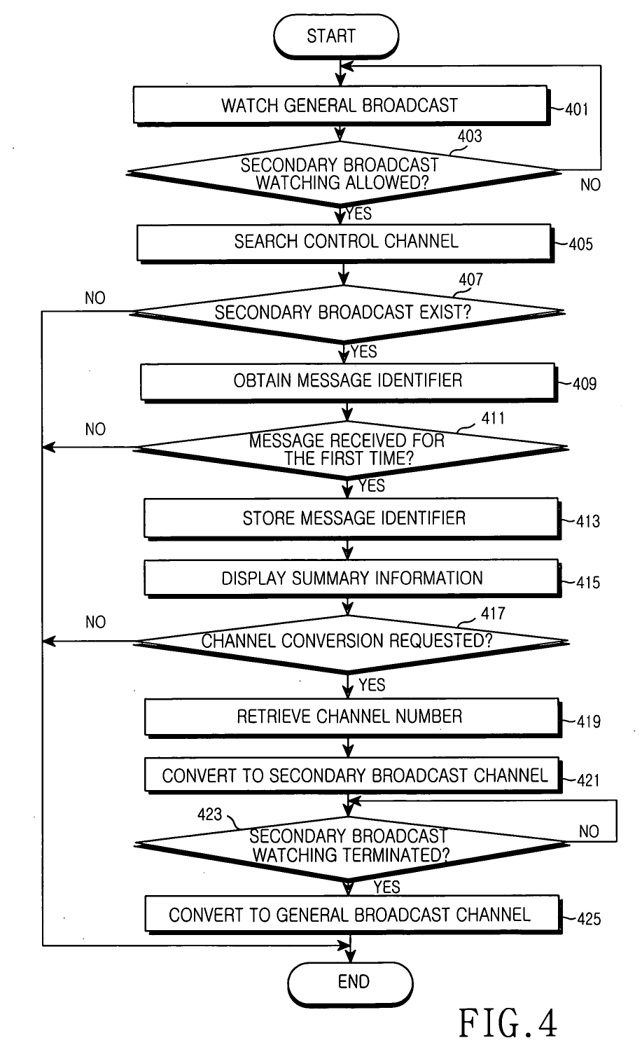

A secondary broadcast reproduction circuit 313 receives the separated summary information of the secondary broadcast, and outputs the information through a display or a speaker according to the type of the received summary information. If the secondary broadcast corresponding to the summary information is being transmitted through a different broadcast channel, a secondary broadcast conversion circuit 325 extracts a channel number corresponding to the different broadcast channel from the summary information, through which the secondary broadcast is being transmitted. The operations of the secondary broadcast extraction circuit 311, the secondary broadcast reproduction circuit 313 and the secondary broadcast conversion circuit 325 will be described in greater detail below with reference to FIG. 4.

A remultiplexing circuit 315 remultiplexes the broadcast channel data streams output from the error corrector 307, and outputs the result to a TS demultiplexer 317. The TS demultiplexer 317 separates the data streams into audio and video transmission packets, etc. Video and audio decoders 319 and 321 decompress the video and audio transmission packet data, and output each through the display 323 and the speaker, respectively.

FIG. 4 is a flowchart showing a method for providing an example secondary broadcast in a digital broadcast receiver in accordance with an embodiment of the present invention. A detailed description will now be given of the method for providing a secondary broadcast and the summary information thereof in the digital broadcast receiver, with reference to FIGS. 3 and 4.

At step 401 of FIG. 4, the digital broadcast receiver provides a general broadcast program, i.e., a broadcast channel program, to a user in conformity with the user's request. At step 403, the receiver checks whether the receiver is allowed to receive a secondary broadcast. The user presets the admissibility of receiving the secondary broadcast. If the admissibility is preset to allow the secondary broadcast reception, the procedure advances to step 405, otherwise the procedure returns to step 401 at which the user continues to watch the general broadcast.

At step 405, a secondary broadcast determination circuit 309 in the receiver searches secondary broadcast sections among the data transmission sections in the control channel and checks at step 407 whether secondary broadcast summary information exists in the searched secondary broadcast sections. If the secondary broadcast summary information exists, the procedure moves to step 409, otherwise the procedure moves to the end at which the procedure is terminated and the user continues to watch the general broadcast.

At step 409, the secondary broadcast extraction circuit 311 separates secondary broadcast summary information from data of the data transmission sections D₃ to D₅₀ output from the error corrector 307, and checks whether summary information separated from secondary broadcast sections in the first frame of a super frame includes a start bit stream, or start code 11. If the separated summary information includes the start code 11, the secondary broadcast extraction circuit 311 detects a message identifier 12. If the separated summary information does not include the start code 11, the secondary broadcast extraction circuit 311 discards the summary information transmitted through the current super frame and checks whether summary information transmitted through the next super frame includes a start bit stream, or start code 11.

At step 411, the secondary broadcast extraction circuit 311 compares the message identifier 12 with a message identifier stored in a memory (not shown), and determines whether it is the first time that the current secondary broadcast is received. If the current secondary broadcast has been received, the procedure moves to the end at which the procedure is terminated and the user continues to watch the general broadcast. However, if the current secondary broadcast has not been received, the procedure moves to step 413 to store the extracted message identifier 12 in the memory, and then moves to step 415.

At step 415, the secondary broadcast extraction circuit 311 extracts a message type 15 and a message body 17 of the secondary broadcast summary information from the summary information, and provides the message type 15 and message body 17 to a secondary broadcast reproduction circuit 313. The secondary broadcast extraction circuit 311 continues to extract the message body 17 until a termination code 18 is detected. The secondary broadcast reproduction circuit 313 reproduces the body and type of the summary information. The reproduced summary information body and type is provided to the user through a display and a speaker. Typically, the summary information is displayed in text on the display. The text of the summary information may be displayed in a fixed form, and may also be displayed in a horizontally scrolling fashion.

The secondary broadcast extraction circuit 311 checks the field of channel flag 13 in the secondary broadcast summary information to determine whether a secondary broadcast corresponding to the summary information is being transmitted through a broadcast channel. If the secondary broadcast is being transmitted through a different broadcast channel, the user is informed via a predetermined icon or a simple text or voice message that he or she can view the detailed content of the summary information, i.e., watch the secondary broadcast, over the different channel.

At step 417, the receiver checks whether the user has input a request for watching a secondary broadcast corresponding to the summary information. If there is no request for watching the secondary broadcast, the procedure moves to the end at which the procedure is terminated and the user continues to watch the general broadcast. If the user has requested to watch the secondary broadcast, a secondary broadcast conversion circuit 325 stores a broadcast channel number currently watched by the user in the memory and the procedure moves to step 419.

At step 419, the secondary broadcast conversion circuit 325 checks the field of channel number 16 in the secondary broadcast summary information to obtain a broadcast channel number through which the secondary broadcast is being transmitted. At step 421, the secondary broadcast conversion circuit 325 provides a spreading code, corresponding to the obtained channel number, to a CDM demodulator 303. The CDM demodulator 303 receives the broadcast channel, through which the secondary broadcast is transmitted, by using the spreading code corresponding to the channel number. The CDM demodulator 303 then outputs the received secondary broadcast through the display 323 and the speaker via an error corrector 307, a remultiplexing circuit 315, a TS demultiplexer 317, an audio decoder 321 and a video decoder 319.

At step 423, the receiver checks whether the user has input a request to terminate the watching of the secondary broadcast. If there is no request to terminate, the user continues to watch the secondary broadcast channel, otherwise the procedure moves to step 425. At step 425, the receiver reads the previous broadcast channel number the user was watching from the memory and provides the corresponding spreading code to the CDM demodulator 303 to convert to the previous broadcast channel. The above procedure is then terminated.

As apparent from the above description, the embodiments of the present invention have an advantage in that it is possible to reduce the inefficiency of broadcast channel capacity by providing the summary information of a secondary broadcast through a control channel. It is also possible to improve the user's convenience by providing a more detailed secondary broadcast in accordance with the user's request after providing the summary information thereof to the user in advance.

Although the embodiments of the present invention have been disclosed above for illustrative purposes, those skilled in the art will appreciate that various modifications, additions and substitutions are possible without departing from the scope and spirit of the invention as disclosed in the accompanying claims.

1. A digital broadcasting system employing a control channel and a plurality of broadcast channels, wherein the control channel is provided for transmitting therethrough a synchronous signal section and a data transmission section alternately, the system comprising:
a transmitter for transmitting summary information and control data of the plurality of broadcast channels through the control channel while allocating the summary information and the control data to the data transmission section, and transmitting a secondary broadcast corresponding to the summary information while allocating the summary information to at least one of the plurality of broadcast channels; and
a receiver for receiving a signal transmitted through the control channel, displaying the summary information retrieved from the data transmission section, and receiving a broadcast channel through which the secondary broadcast corresponding to the summary information is transmitted when there is a request to receive the secondary broadcast.

2. The system according to claim 1, wherein the data transmission section is divided into a control data section and a secondary broadcast section.

3. The system according to claim 2, wherein the transmitter comprises:
a first multiplexer for allocating the control data and the summary information to the control data section and the secondary broadcast section, respectively, and allocating a predetermined synchronous signal to the synchronous signal section.

4. The system according to claim 1, wherein the transmitter further comprises:
a second multiplexer for multiplexing the control data and the summary information.

5. The system according to claim 1, wherein the summary information comprises a broadcast channel number through which the secondary broadcast is transmitted.

6. The system according to claim 5, wherein the receiver comprises:
a secondary broadcast determination circuit for checking whether the summary information is present in the secondary broadcast section;
a secondary broadcast extraction circuit for extracting the summary information from the secondary broadcast section; and
a secondary broadcast conversion circuit for retrieving the broadcast channel number from the summary information, through which the secondary broadcast is transmitted.

7. A digital broadcasting system employing a control channel and a plurality of broadcast channels, wherein the control channel is provided for transmitting therethrough a synchronous signal section and a data transmission section alternately, the system comprising:
a transmitter for dividing the data transmission section into a control data section and a secondary broadcast section, for multiplexing summary information, control data of the broadcast channels and a predetermined synchronous signal by allocating each to the secondary broadcast section, the control data section and the synchronous signal section, respectively, and for transmitting the multiplexed summary information, control data of the broadcast channels and a predetermined synchronous signal through the control channel; and
a receiver for receiving a signal transmitted through the control channel, determining whether the summary information is present in the secondary broadcast section, and providing the summary information to a user after extracting the information from the secondary broadcast section.

8. The system according to claim 7, wherein the transmitter transmits a secondary broadcast corresponding to the summary information through at least one of the plurality of broadcast channels, and the receiver receives the at least one broadcast channel, through which the secondary broadcast is transmitted, in accordance with a user's request.

9. The system according to claim 8, wherein the summary information comprises a channel number of the at least one broadcast channel through which the secondary broadcast is transmitted.

10. The system according to claim 9, wherein the receiver comprises a secondary broadcast conversion circuit for retrieving the channel number of the at least one broadcast channel from the summary information, through which the secondary broadcast is transmitted.

11. The system according to claim 1, wherein the summary information comprises a message identifier for identifying the secondary broadcast, and the receiver comprises a memory for storing the message identifier.

12. The system according to claim 11, wherein the summary information comprises start and end codes and information representing the summary information size and type.

13. A device for receiving a secondary broadcast in a digital broadcasting system employing a control channel and a plurality of broadcast channels, the control channel comprising a synchronous signal section and a data transmission section arranged alternately, the device comprising:
a receiver for receiving signals of the control channel and a channel selected by a user from the plurality of broadcast channels;
a secondary broadcast determination means for determining whether summary information of a secondary broadcast is present in the data transmission section of the control channel at a predetermined position thereof;
a secondary broadcast extractor for extracting the summary information transmitted while being inserted in the data transmission section at the predetermined position thereof; and
a secondary broadcast reproducer for reproducing the extracted summary information and providing the extracted summary information to the user.

14. The device according to claim 13, further comprising:
a secondary broadcast converter for retrieving a broadcast channel number from the summary information, through which the secondary broadcast is transmitted, and controlling the receiver to receive a broadcast channel corresponding to the broadcast channel number.

15. The device according to claim 13, wherein the summary information includes a message identifier for identifying the secondary broadcast, and the device further comprising a memory for storing the message identifier.

16. The device according to claim 13, wherein the summary information includes start and end codes and information representing the summary information size and type.

17. A method for receiving a secondary broadcast in a digital broadcasting system employing a control channel and a plurality of broadcast channels, the control channel comprising a synchronous signal section and a data transmission section arranged alternately, the method comprising the steps of:
a) receiving the control channel and a broadcast channel selected by a user from the plurality of broadcast channels, and providing a program of the selected broadcast channel to the user;
b) searching a secondary broadcast section in the data transmission section of the control channel to determine whether there is summary information;
c) extracting the summary information from the secondary broadcast section; and
d) reproducing the extracted summary information and providing the extracted summary information to the user.

18. The method according to claim 17, further comprising the step of:
e-1) receiving a secondary broadcast corresponding to the summary information in accordance with the user's request, and providing the secondary broadcast to the user.

19. The method according to claim 18, further comprising the step of:
e-2) determining whether the secondary broadcast corresponding to the summary information is being transmitted through at least one of the plurality of broadcast channels.

20. The method according to claim 19, further comprising the step of:
e-3) checking whether the summary information includes a channel number of the at least one broadcast channel.

21. The method according to claim 19, further comprising the step of:
f) displaying whether the secondary broadcast is being transmitted through the at least one broadcast channel.

22. A method for providing a secondary broadcast in a digital broadcasting system employing a control channel and a plurality of broadcast channels, the control channel transmitting therethrough a synchronous signal section and a data transmission section alternately, the method comprising the steps of:
a) dividing the data transmission section into a control data section and a secondary broadcast section, and allocating summary information and control data of the broadcast channels to the secondary broadcast section and the control data section, respectively;
b) multiplexing the data transmission section and the synchronous signal section while arranging the data transmission section and the synchronous signal section alternately, and transmitting the multiplexed data transmission section and the synchronous signal section through the control channel;
c) receiving a signal transmitted through the control channel, and determining whether there is summary information in the secondary broadcast section; and
d) reproducing the summary information after extracting the summary information from the secondary broadcast section.

23. The method according to claim 22, further comprising the steps of:
e) transmitting a secondary broadcast corresponding to the summary information through at least one of the plurality of broadcast channels; and
f) receiving a secondary broadcast transmitted through the at least one broadcast channel in accordance with a user's request, and providing the secondary broadcast to the user.

24. The method according to claim 23, wherein the summary information comprises a channel number of the at least one broadcast channel through which the secondary broadcast is transmitted.

25. The method according to claim 23, wherein the step f) further comprises the step of:
displaying whether the secondary broadcast is being transmitted through the at least one broadcast channel.

26. A method for receiving a secondary broadcast in a digital broadcasting system employing a control channel and a plurality of broadcast channels, the control channel comprising a synchronous signal section and a data transmission section arranged alternately, the method comprising the steps of:
a) receiving the control channel and a broadcast channel selected by a user from the plurality of broadcast channels, and providing a program of the selected broadcast channel to the user;
b) searching a secondary broadcast section in the data transmission section of the control channel to determine whether there is summary information;
c) reproducing the summary information after extracting the summary information from the secondary broadcast section;
d) retrieving a broadcast channel of the plurality of broadcast channels from the summary information, through which a secondary broadcast corresponding to the summary information is transmitted; and
e) converting into the broadcast channel through which the secondary broadcast is transmitted in accordance with the user's request.

27. The method according to claim 26, wherein the step d) further comprises the steps of:
d-1) determining whether the summary information includes a broadcast channel number of the broadcast channel through which the secondary broadcast is transmitted; and
d-2) extracting the broadcast channel number from the summary information.

28. The method according to claim 26, wherein the step e) further comprises the step of:
e-1) displaying whether the secondary broadcast is being transmitted through the broadcast channel.

29. The method according to claim 17, further comprising the steps of:
g) comparing the summary information with previously received summary information to determine whether the summary information and previously received summary information are identical; and
h) preventing the display of the summary information when the summary information and previously received summary information are identical.

30. The method according to claim 29, wherein the step g) further comprises the step of:
g-1) comparing a message identifier included in the summary information with a message identifier stored in a memory.

31. The method according to claim 30, further comprising the step of:
i) storing the message identifier included in the summary information in the memory.

32. The method according to claim 17, wherein the summary information comprises start and end codes.

33. The method according to claim 32, wherein the step of searching a secondary broadcast section in the data transmission section of the control channel to determine whether there is summary information further includes the step of checking whether the secondary broadcast section includes the start code.

34. The method according to claim 18, further comprising the steps of:
j) storing a broadcast channel number of a broadcast channel selected by the user; and
k) resuming receipt of the broadcast channel, whose channel number is stored at the step j), when a user inputs a request to terminate watching of the secondary broadcast.

35. The system according to claim 7, wherein the summary information comprises a message identifier for identifying the secondary broadcast, and the receiver comprises a memory for storing the message identifier.

36. The system according to claim 35, wherein the summary information comprises start and end codes and information representing the summary information size and type.

37. The method according to claim 22, further comprising the steps of:
g) comparing the summary information with previously received summary information to determine whether the summary information and previously received summary information are identical; and
h) preventing the display of the summary information when the summary information and previously received summary information are identical.

38. The method according to claim 37, wherein the step g) further comprises the step of:
g-1) comparing a message identifier included in the summary information with a message identifier stored in a memory.

39. The method according to claim 38, further comprising the step of:
i) storing the message identifier included in the summary information in the memory.

40. The method according to claim 26, further comprising the steps of:
g) comparing the summary information with previously received summary information to determine whether the summary information and previously received summary information are identical; and
h) preventing the display of the summary information when the summary information and previously received summary information are identical.

41. The method according to claim 40, wherein the step g) further comprises the step of:
g-1) comparing a message identifier included in the summary information with a message identifier stored in a memory.

42. The method according to claim 41, further comprising the step of:
i) storing the message identifier included in the summary information in the memory.

43. The method according to claim 22, wherein the summary information comprises start and end codes.

44. The method according to claim 43, wherein the step of searching a secondary broadcast section in the data transmission section of the control channel to determine whether there is summary information further includes the step of checking whether the secondary broadcast section includes the start code.

45. The method according to any one of claims 26, wherein the summary information comprises start and end codes.

46. The method according to claim 45, wherein the step of searching a secondary broadcast section in the data transmission section of the control channel to determine whether there is summary information further includes the step of checking whether the secondary broadcast section includes the start code.

47. The method according to claim 26, further comprising the steps of:
j) storing a broadcast channel number of a broadcast channel selected by the user; and
k) resuming receipt of the broadcast channel, whose channel number is stored at the step j), when a user inputs a request to terminate watching of the secondary broadcast.
